(19) United States
(12) Patent Application Publication
(10) Pub. No.: US 2004/0195221 A1
(43) Pub. Date: Oct. 7, 2004

(54) Method and apparatus for laser ablative modification of dielectric surfaces

(76) Inventors: Richard F. Haglund Jr, Nashville, TN (US); David Ermer, Mississippi, MS (US)

Correspondence Address: Danny L Williams, Williams Morgan & Amerson, Suite 1100, 10333 Richmond Avenue, Houston, TX, 77042, US

(21) Appl. No.: 10/476,687

(22) PCT Filed: May 9, 2002
(86) PCT No.: PCT/US02/14893

Related U.S. Application Data
(60) Provisional application No. 60/289,956, filed on May 10, 2001.

(51) Int. Cl. B23K 26/40

(52) U.S. Cl. 219/121.69; 219/121.68

(57) ABSTRACT

The present invention provides a method and apparatus (100) for laser (101) ablative modification of surfaces (120). The apparatus (100) includes a controller adapted to determine the wavelength corresponding to a characteristic wavelength of the absorption band, as well as an intensity and a duration such that a light pulse with the determined wavelength, intensity, and duration is capable of heating the portion of the dielectric material (120) to approximately the critical temperature of the dielectric material on a time scale less than about the characteristic time scale for thermal diffusion in the dielectric material and thereby inducing a phase explosion in the dielectric material. The apparatus further includes a laser (101) capable of providing at least one light pulse with the determined wavelength, intensity and duration in response to a signal from the controller.

### CROSS REFERENCE TO RELATED APPLICATIONS

This application claims priority to provisional U.S. Patent Application No. 60/289,956, filed on May 10, 2001.

### STATEMENT REGARDING FEDERALLY SPONSORED RESEARCH OR DEVELOPMENT

This work was supported in part by the Office of Naval Research under the Medical Free-Electron Laser Program (Contract N00014-94-1-1023); the Office of Science, U.S. Department of Energy (Contract DE-FG07-98ER62710); Vanderbilt's Molecular Biophysics Training Grant funded by the National Institutes of Health, Number 2T32GM08320-19; and the Research Experience for Undergraduates Program of the National Science Foundation, Grant Number 99-104352.

### BACKGROUND OF THE INVENTION

1. Field of the Invention

This invention relates generally to lasers, and, more particularly, to laser ablative modification of dielectric surfaces.

2. Description of the Related Art

Laser systems may be used to direct concentrated beams of coherent light onto surfaces of materials. If the intensity of the laser light is great enough, the energy deposited by the absorbed light may heat the surface, producing chemical and physical breakdown of the material, disintegration, ablation, vaporization, and other similar processes that may modify the surface. For example, the laser light beams may form craters on the surface of the material. These so-called laser ablation, or laser drilling, processes may be used to modify surfaces of a wide variety of materials such as bone, glass, semiconductors, and the like. For example, lasers, including a Ti:Sapphire oscillator, have been used to drill 0.3 μm holes in silver and aluminum films.

When used in a controlled manner, laser ablation may be useful in several technological areas. For example, laser drilling or cutting may be used to perform medical procedures such as hard-tissue surgery. Laser ablation may also be used to fabricate semiconductor structures. For example, vias may be etched in semiconductor substrates using lasers. In fact, several years ago, the worldwide market for the relatively new technology of laser drilling of dielectric materials was already estimated to be about $730 million dollars (See, e.g. H. Feufel, Elektronik 47, pp. 56-61, 1998).

Laser ablation of dielectric materials is typically performed by inducing dielectric breakdown using a pulsed laser beam. For example, the pulsed laser beam may comprise individual pulses, which may last from 10 femtoseconds to 100s of nanoseconds, separated by periods of quiescence. In traditional laser-induced breakdown methods, such as that described by Gerard Mourou et al. (U.S. Pat. No. 5,656,186, hereinafter referred to as the '186 patent”), the pulsed laser beam, which may have a duration of roughly 100 femtoseconds, is focused on a predetermined spot at, or just below, the surface of the material. The pulse duration and the intensity of the beam are then adjusted to deliver a desired amount of energy to the spot in a predetermined amount of time.

However, the conventional laser ablation methods using dielectric breakdown suffer from a number of drawbacks. The wavelengths of the light typically employed in laser-induced breakdown (e.g. 200 and 800 nanometers in the '186 patent) may lead to cracking, crazing, and other undesirable deformations of the surface near the spot at which the laser energy is deposited. The deformations may reduce the structural integrity of the material. Light at these wavelengths may also induce electronic excitations in the material that may cause undesirable photochemical reactions to occur in the material. Furthermore, it is well-known that laser-induced breakdown is not an effective method of ablating many dielectric materials. An ultra-fast laser, which may provide light pulses as short as 1 picosecond, may be used to induce breakdown, but ultra-fast lasers are very expensive. The price of the ultra-fast laser may range from $150,000 to $600,000 depending on wavelength, tunability, pulse energy, and/or pulse duration.

### SUMMARY OF THE INVENTION

In one aspect of the instant invention, an apparatus is provided for laser ablative modification of surfaces. The apparatus includes a controller adapted to determine a wavelength corresponding to a characteristic wavelength of the absorption band, as well as an intensity and a duration such that a light pulse with the determined wavelength, intensity, and duration is capable of heating the portion of the dielectric material to approximately the critical temperature of the dielectric material on a time scale less than about the characteristic time scale for thermal diffusion in the dielectric material and thereby inducing a phase explosion in the dielectric material. The apparatus further includes a laser capable of providing at least one light pulse with the determined wavelength, intensity, and duration in response to a signal from the controller.

In one aspect of the present invention, a method is provided for laser ablative modification of surfaces. The method includes determining a wavelength using optical properties of a material. The method further includes determining a light intensity and a duration using optical and thermodynamic properties of the material and the determined wavelength. The method further includes providing light having the determined wavelength to ablate a portion of the material by inducing a phase explosion, wherein the pulse has the determined wavelength, intensity, and duration.

### BRIEF DESCRIPTION OF THE DRAWINGS

The invention may be understood by reference to the following description taken in conjunction with the accompanying drawings, in which like reference numerals identify like elements, and in which:

FIG. 1 shows a block diagram of a system that may be used to perform laser ablation, in accordance with one embodiment of the present invention;

FIGS. 2A-D show stylized representations of a sample that may be laser ablated in the system shown in FIG. 1, in accordance with one embodiment of the present invention;

FIGS. 3A-B show images of craters formed in laser ablated samples of fused silica, in accordance with one embodiment of the present invention;

FIGS. 4A-B show images of craters formed in laser ablated samples of calcite and Pyrex®, respectively, in accordance with one embodiment of the present invention; and

FIGS. 5A-B show block diagrams of a plurality of craters formed in laser ablated samples, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

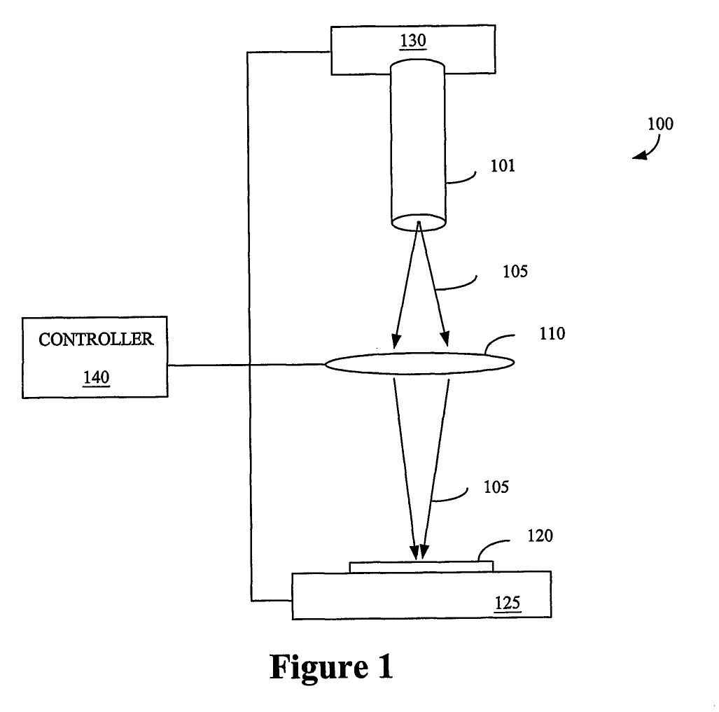

Referring now to FIG. 1, a block diagram of a system 100 that may be used to perform laser ablation is shown. The system 100 includes a laser 101 that may provide a beam 105 of coherent, substantially monochromatic light. In one embodiment, the laser 101 may be an infra-red laser such as a free-electron laser (FEL), which may provide laser light at a wavelength ranging from 2 micrometers to 10 micrometers. However, it will be appreciated that the instant invention is not so limited. In alternative embodiments, the laser 101 may be a high-pressure CO₂ gas laser producing ultrafast pulses, a solid-state laser system employing nonlinear optical means to shift the wavelength into the mid-infrared, and the like that may provide light at wavelengths outside of the infra-red range without departing from the scope of the present invention.

The laser 101 may, in one embodiment, provide one or more 4-μs-long macropulses that may have laser fluences ranging from about 1 mJ/cm² to about 100 mJ/cm². The macropulses may be divided into a plurality of micropulses. For example, the macropulse may include 20,000 micropulses and the duration of each micropulse may be about 0.7 picoseconds to about 1.0 picoseconds. However, it will be appreciated that the instant invention is not so limited. In alternative embodiments, the laser 101 may provide macropulses that have laser fluences less than about 1 mJ/cm² or greater than about 100 mJ/cm² without departing from the scope of the present invention. In addition, the macropulse may be divided into more or fewer micropulses having a duration shorter that 0.7 picoseconds or longer that 1.0 picoseconds without departing from the scope of the present invention.

The beam 105 may pass through an optical element 110, which may focus the beam 105 onto a portion of a sample 120, which may be positioned on a base 125. In one embodiment, the optical element 110 maybe a lens, but the present invention is not so limited. In alternative embodiments, the optical element 110 may include any desirable combination of devices such as lenses, mirrors, filters, polarizers, and the like without departing from the scope of the present invention. In one embodiment, the sample 120 may be a dielectric material. Although the present invention is not so limited, the dielectric material that forms the sample 120 may be a brittle dielectric material such as bone, glass, silica, calcite, Pyrex®, and the like. In alternative embodiments, the dielectric material may also comprise compound semiconductors, polymers, organic crystals and solids, and the like without departing from the scope of the present invention.

The beam 105 may, in one embodiment, be focused upon different portions of the sample 120 by changing the relative positions of the laser 101 and the sample 120. For example, the laser 101 may be coupled to a movable support element 130. By moving the laser 101 using the movable support element 130, the beam 105 may be focused upon different portions of the sample 120. For another example, the base 125 may be capable of changing the position of the sample 120 and the beam 105 maybe focused upon different portions of the sample 120 by moving the sample 120 using the base 125.

The beam 105 may also be focused upon different portions of the sample 120 using the optical element 110. In one embodiment, the optical element 110 may be formed from elements (not shown) that may allow the optical element 110 to be adjusted to focus the beam 105 on different portions of the sample 120. For example, the optical element 110 may comprise one or more mirrors (not shown) that may be used to direct the beam 105 to desirable portions of the sample 120. Similarly, one or more lenses (not shown) may be used to direct the beam 105 to desirable portions of the sample 120, as well as to change the size of the beam 105.

A controller 140 may be coupled to the movable support element 130, the optical element 110, the base 125, and any other desirable elements of the system 100. In one embodiment, the controller 140 may determine a desired configuration of the system 100 and may provide one or more signals to at least one of the movable support element 130, the optical element 110, and the base 125 to indicate the desired configuration. The movable support element 130, the optical element 110, and/or the base 125 may then use the provided signal to form the desired configuration. For example, and as discussed in detail below, the controller 140 may provide signals that may be used by the movable support element 130, the optical element 110, and/or the base 125 to form a pattern in the sample 120.

Clean and efficient ablation of the portion of the sample 120 can be accomplished by quickly depositing enough energy into a very small volume to superheat the volume to approximately a critical temperature and induce explosive homogeneous nucleation of the vapor phase, i.e. a phase explosion. A phase explosion may occur when the temperature of the portion exceeds approximately the critical temperature of the sample 120, as will be appreciated by those of ordinary skill in the art. For example, the critical temperature of fused silica is 2500° K. The phase explosion may ablate material from the portion of the sample 120. However, as the temperature rises towards the critical temperature, heat may diffuse out of the portion and raise the temperature of surrounding material in the sample 120. Although a phase explosion may still occur, diffusion of heat out of the portion may cause cracking, crazing, and other undesirable deformations in other parts of the sample 120. Thus, in accordance with one embodiment of the present invention, the optical and thermodynamic properties of the sample 120 may be used to determine a laser wavelength, a laser pulse width, and a laser intensity such that the beam 105 may superheat the portion to approximately the critical temperature in less than the diffusion time for the sample.

In one embodiment, superheating may be accomplished by tuning the laser 101 to a wavelength that corresponds to an absorption band of the dielectric material in the sample 120. Thus, in accordance with one embodiment of the present invention, the intrinsic thermodynamic and optical properties of the material in the sample 120 may be used to calculate a wavelength that is absorbed by the material. For example, the controller 140 may be used to determine the absorbed wavelength using a known absorption spectrum of the material, an empirical relation, a direct measurement, a computer model of the material, and the like.

The absorbed wavelength may be, in one embodiment, a strong vibrational resonance of the material in the sample 120. The intrinsic thermodynamic and optical properties of the material in the sample 120 may also be used to determine a desirable pulse width and a fluence of the pulse. For example, the controller 140 maybe used to determine a pulse duration that is shorter than about the characteristic time scale for thermal diffusion in the material. The controller 140 may also be used to tune the laser 101 to the absorbed wavelength of the sample 120, and to direct the laser 101 to provide a beam 105 of pulses with the determined pulse width and fluence that may be focused on a portion of the sample 120 to cause the desired phase explosion.

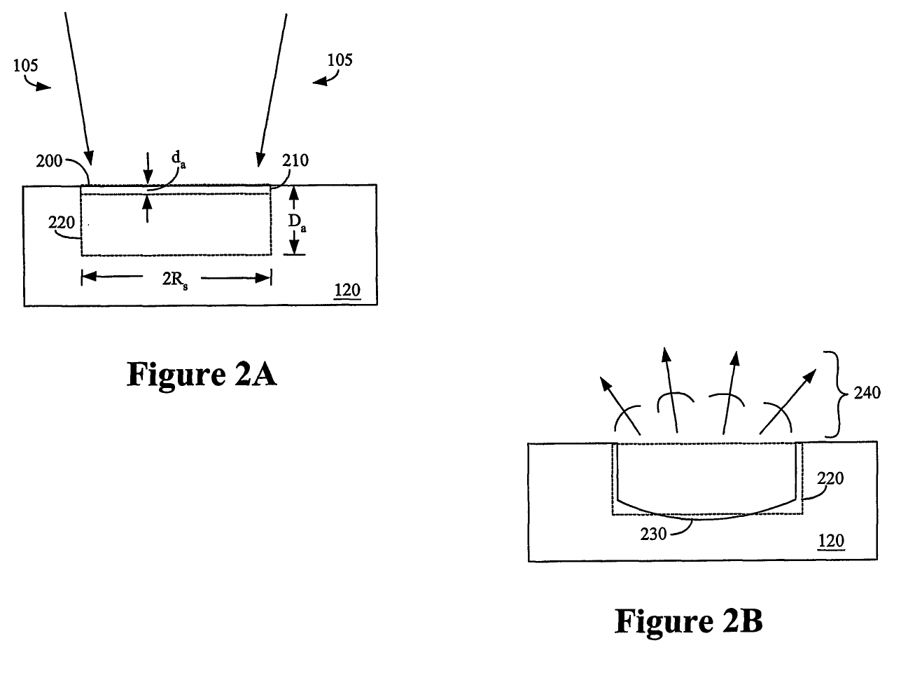

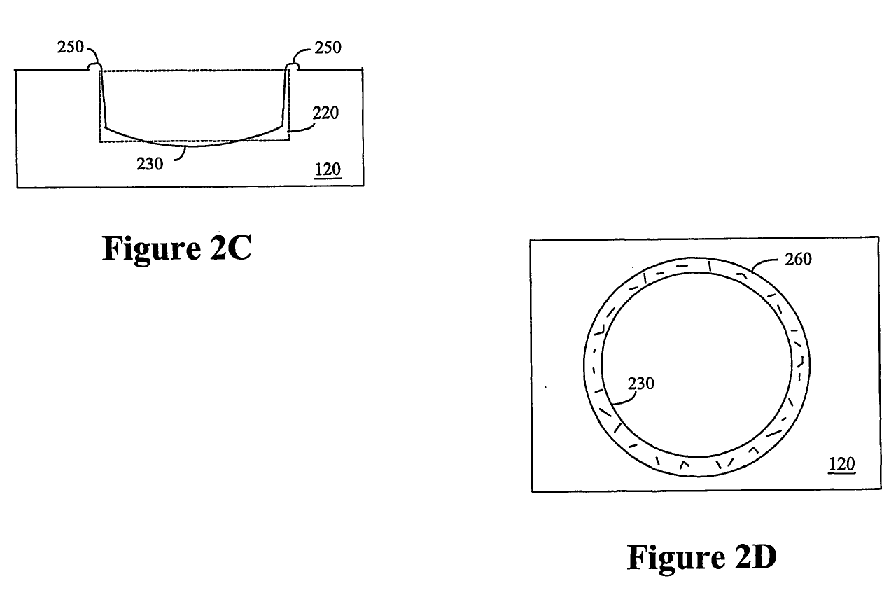

Turning now to FIG. 2A, a stylized representation of the sample 120 is shown. The sample 120 may be formed of a dielectric material. In one embodiment, the dielectric material may be a brittle dielectric material. For example, the sample 120 may be formed of calcite, the crystalline form of calcium carbonate (CaCO₃), which is a basic component of biominerals and hard tissues such as bones, teeth, and the like. For another example, the sample 120 may be formed of fused silica (SiO₂), which is a principal component of many lenses, windows, waveguides, substrates, and the like. For yet another example, the sample 120 may be formed of Pyrex®, which is widely used in many commercially produced items.

The beam 105 may be focused onto a portion 200 that is at or near the surface of the sample 120. In one embodiment, the surface area of the portion 200 may be determined by the laser 101 and the optical element 110. For example, the optical element 110 may focus the beam 105 onto a spot on the sample 120 that covers an approximately circular area with a radius of Rₛ. It will be appreciated, however, that the present invention is not so limited. In alternative embodiments, the shape of the spot may be elliptical, rectangular, triangular, or any other desirable shape with any desirable dimensions.

The optical properties of the sample 120 may be used to determine one or more wavelengths that are in one or more absorption bands of the sample 120. For an example of an absorption band, calcite has a strong vibrational absorption resonance at a wavelength of about 7.1 μm. For another example, silica has a strong absorption resonance at a wavelength of about 9.2 μm, which is caused by the Si—O stretch. The one or more wavelengths of the sample 120 may, in alternative embodiments, be determined from known absorption spectra, empirical relations, direct measurements, computer models of the material in the sample 120, and the like.

Energy in each micropulse of the beam 105 at about the determined wavelength may be absorbed in an absorption layer 210. The thickness of the absorption layer 210 is approximately equal to a so-called absorption depth dₐ of the sample 120. For example, calcite has a vibrational absorption resonance at a wavelength of 7.1 μm and the absorption depth dₐ of calcite may be about 0.2 μm for a wavelength of about 7.1 μm. For another example, silica has an absorption resonance at a wavelength of 9.4 μm and the absorption depth dₐ of silica may be about 0.2 μm for a wavelength of about 9.2 μm.

The beam 105 may provide at least one macropulse to the portion 200 of the sample 120. The macropulse may include a plurality of micropulses. For example, the macropulse may include 20,000 micropulses and the duration of each micropulse may be about 0.7 picoseconds to about 1.0 picoseconds. Initially, the micropulses may be absorbed in the absorption layer 210 and may heat the absorption layer 210 to approximately the critical temperature, which may cause a phase explosion that may remove a substantial portion of the material in the absorption layer 210. The phase explosion may also expose material below the absorption layer 210. The following micropulses may then heat underlying layers (not shown) to approximately the critical temperature, allowing the phase explosion to ablate material that is deeper in the sample 120. Consequently, the macropulse may ablate material from a crater 230 having a total ablation depth of about Dₐ. This depth will depend on the intensity and duration of the laser pulse and can be substantially greater than the absorption depth dₐ.

The macropulse may create a dense vibrational excitation in a volume of the sample 120 that may be defined approximately by the area of the laser spot on the sample 120 multiplied by the penetration depth of the beam 105. As shown in FIG. 2B, in one embodiment, the phase explosion may cause the ablated material 240 to be removed and ejected from the surface of the sample 120. For example, the ablated material 240 may be vaporized by the phase explosion. Thus, a crater 230 may be formed in the sample 120. The crater 230 may, in one embodiment, have lateral dimensions that are approximately equal to the lateral dimensions of the laser beam 105. However, the present invention is not so limited and one or more lateral dimensions of the crater 230 may be substantially different than the corresponding dimensions of the laser beam 105. For example, the phase explosion may cause material that is not within the lateral dimensions of the laser beam 105 to be ablated. For another example, the phase explosion may create a crater 230 that is narrower than the lateral dimensions of the laser beam 105 if the phase explosion does not efficiently remove materials at the edges of the laser beam 105. It will be appreciated, however, that the above examples are merely illustrative and not intended to limit the scope of the present invention. In alternative embodiments, the crater 230 may be wider or narrower than the lateral dimension of the laser beam 105, and/or deeper or shallower than the absorption depth dₐ without departing from the scope of the present invention.

Additionally, a portion of the ablated material 240 may fall back into and/or around the crater 230. Ablated material 240 that falls back into the crater 230 may reduce the volume of the crater 230. For example, a single micropulse may raise the temperature of a portion of the sample 120 extending to a depth of dₐ to approximately the critical temperature, causing a phase explosion that may initially form a crater that has a depth of about dₐ. However, a portion of the material may fall back, reducing the depth of the crater 230 to substantially less than dₐ. And as shown in FIG. 2C, a portion of the ablated material 240 may also fall back around the crater 230 and may form a rim 250 outside the crater 230.

FIG. 2D shows a block diagram of the sample 120 as seen from the direction of the incident beam 105. In one embodiment, the crater 230 may be approximately circular. It will be appreciated, however, that the present invention is not so limited. In alternative embodiments, the crater 230 may be rectangular, triangular, or any other desirable shape without departing from the scope of the present invention.

A heat-affected zone 260 typically surrounds the crater 230. The heat affected zone 260 may be formed by heat that diffuses out of the ablated layer 220 before the ablated layer 220 reaches approximately the critical temperature. Thermal stresses in the heat-affected zone 260 may cause cracking, crazing, and/or other undesirable deformations of the sample 120 (indicated in FIG. 2D by various dashes and lines). The size of the heat-affected zone 260 may be reduced by tuning the wavelength of the laser beam 105 (see FIG. 1) to be about equal to the wavelength that corresponds to a characteristic wavelength of an absorption band of the dielectric material in the sample 120, in accordance with one embodiment of the present invention. In addition, when the laser wavelength is so tuned, increasing the intensity of the laser beam may further reduce the size of the heat-affected zone 260.

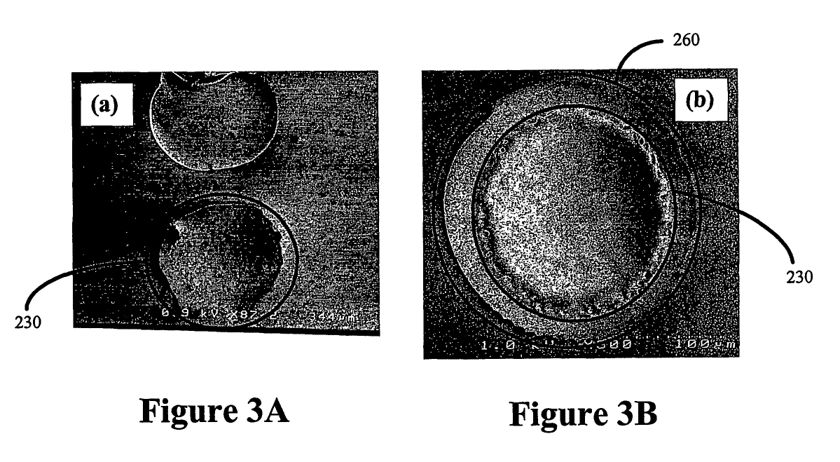

Turning now to FIGS. 3A-B, images of craters 230 formed in fused silica are shown. The crater 230 in FIG. 3B was formed by a 4 μs macropulse at an intensity of 4×10⁷ W/cm² from an FEL laser tuned to a wavelength of 9.41 μm. The fused silica absorption depth of the 9.4 μm wavelength is about 0.4 μm. Fracturing, melted glass, and other undesirable surface modifications are visible within the heat-affected zone 260 around the crater 230 in FIG. 3B.

By tuning the FEL laser to a wavelength that is more strongly absorbed, in accordance with one embodiment of the present invention, the size of the heat-affected zone 260 may be reduced. For example, the corresponding crater 230 in FIG. 3A was formed by a 4 μs macropulse at an intensity of 4×10⁷ W/cm² from an FEL laser tuned to a wavelength of 9.2 μm. Light with a wavelength of 9.2 μm has an absorption depth in fused silica of 0.2 μm, i.e. one-half the absorption depth of light with a wavelength of about 9.4 μm, implying that fused silica preferentially absorbs light at a wavelength of 9.2 μm, relative to light at 9.4 μm. Thus, the size of the heat-affected zone 260 in fused silica may be reduced by tuning the FEL laser to 9.2 μm. In fact, no heat-affected zone 260 is visible around the crater 230 in FIG. 3A.

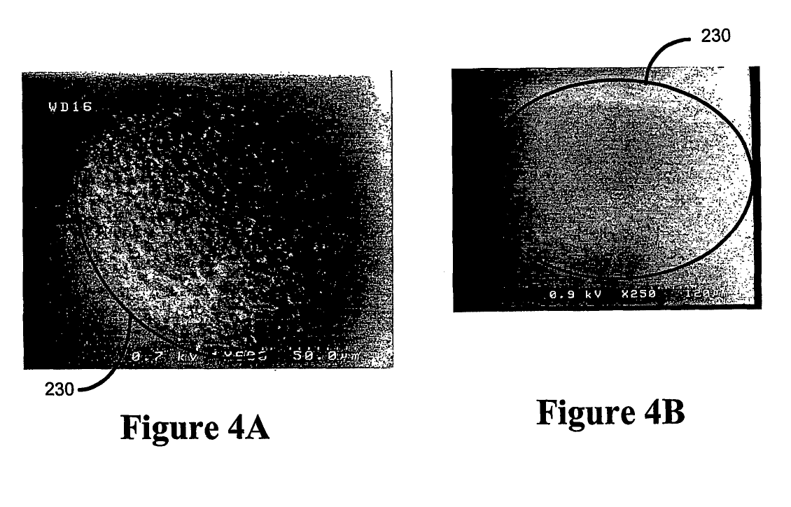

FIG. 4A shows an image of a crater 230 formed in calcite, in accordance with one embodiment of the present invention. The crater 230 was formed by a 4 μs macropulse at an intensity of 4×10⁷ W/cm² from an FEL laser tuned to a wavelength of 7.1 μm, which corresponds to an absorption band of calcite. The crater 230 is clean and fracture-free, showing no evidence of a heat-affected zone 260. FIG. 4B shows an image of a crater 230 formed in Pyrex®, in accordance with one embodiment of the present invention. The crater 230 was formed by a 4 μs macropulse at an intensity of 4×10⁷ W/cm² from an FEL laser tuned to a wavelength of 9.2 μm, which corresponds to an absorption band of Pyrex®. The crater 230 is again clean and fracture-free, showing no evidence of a heat-affected zone 260.

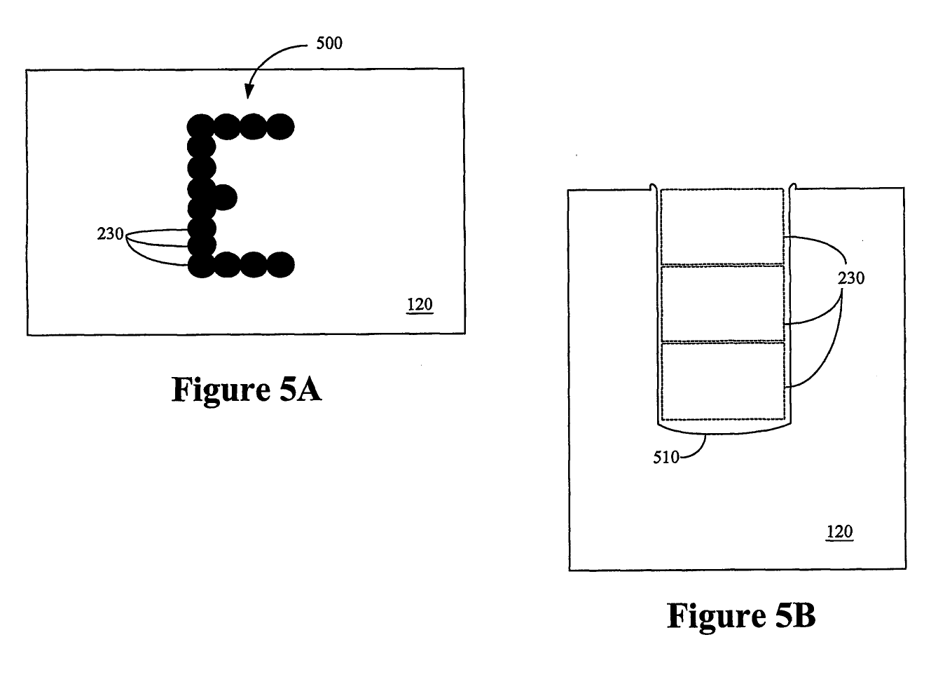

Laser ablation may also be used to form more complex features in the sample 120. In one embodiment, a plurality of craters 230 may be employed to form a pattern 500 in the sample 120, such as the “E” shown in FIG. 5A. The location of the craters 230 may be determined using the various methods of changing the relative position of the laser 101 and the sample 120, as discussed above in conjunction with FIG. 1. In an alternative embodiment shown in FIG. 5B, a deep crater 510 may be formed in the sample by forming a plurality of craters 230 at substantially the same place in the sample 120. It will be appreciated, however, that the instant invention is not limited by the aforementioned examples. Any desirable pattern of craters 230 and/or deep craters 510 may be formed in the sample. 120 without departing from the scope of the present invention.

Although the above discussion made reference to the laser 101 that may be tuned to wavelengths corresponding to a vibrational absorption band of the sample 120, the present invention is not so limited. In various alternative embodiments of the present invention, the aforementioned techniques may be applied anytime sufficient energy is deposited in the sample 120 at a rate that may heat a portion of the sample 120 to approximately the critical temperature on a time scale comparable to, or less than, the characteristic thermal diffusion time of the material. A phase explosion may then be generated in the sample 120 and the heat-affected zone 260 (see FIG. 2) may be reduced.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
determining a wavelength using optical properties of a material;
determining a light intensity and a duration using optical and thermodynamic properties of the material and the determined wavelength; and
providing light having the determined wavelength to ablate a portion of the material by inducing a phase explosion, wherein the pulse has the determined wavelength, intensity, and duration.

2. The method of claim 1, wherein determining the wavelength comprises determining a wavelength corresponding to an absorption band of the material.

3. The method of claim 2, wherein determining the wavelength corresponding to an absorption band wavelength comprises determining a wavelength corresponding to a vibrational absorption band of the material.

4. The method of claim 1, wherein determining the wavelength comprises determining the wavelength such that the wavelength is less than or equal to a wavelength corresponding to a band gap of the material.

5. The method of claim 1, wherein determining the wavelength comprises determining the wavelength using at least one of a known absorption spectrum, an empirical relation, a direct measurement, and a computer model of the material.

6. The method of claim 1, wherein determining the light intensity and the duration using optical and thermodynamic properties of the material and the determined wavelength comprises determining the light intensity and the duration such that the portion of the material is heated to approximately a critical temperature of the material on a time scale less than about the characteristic time scale for thermal diffusion in the material.

7. The method of claim 1, wherein providing the light comprises providing at least one pulse of light with a laser.

8. The method of claim 7, wherein providing the pulse of light with the laser comprises providing the pulse of light with a free-electron laser.

9. The method of claim 8, wherein providing the pulse of light with the free-electron laser comprises providing the pulse of light with an infra-red free-electron laser.

10. The method of claim 7, wherein providing the pulse of light with the laser comprises providing the pulse of light with at least one of a high-pressure CO₂ infrared-active gas laser, an infra-red gas laser, and a solid-state laser operating in the infrared portion of the spectrum from roughly 1.5 to 15 micrometers.

11. The method of claim 7, wherein providing the pulse of light with the laser comprises providing a macropulse including a plurality of micropulses.

12. The method of claim 11, wherein providing the macropulse comprises providing a 4 μs macropulse.

13. The method of claim 11, wherein providing the macropulse including a plurality of micropulses comprises providing the macropulse including a plurality of micropulses with a duration of about 0.7 picoseconds to about 1.0 picoseconds.

14. The method of claim 7, wherein providing the pulse of light with the laser comprises providing the pulse of light at an intensity of at least about 4×10⁷ W/cm² with the laser.

15. The method of claim 1, wherein providing the pulse of light comprises focusing the pulse of light using an optical element.

16. The method of claim 1, further comprising providing a plurality of pulses of light.

17. A method for ablating a portion of a dielectric material, comprising:
determining an absorption band wavelength of the dielectric material;
determining an intensity and a duration of at least one pulse of light at the determined wavelength such that the pulse is capable of heating the portion of the dielectric material to approximately the critical temperature of the dielectric material on a time scale less than about the characteristic time scale for thermal diffusion in the dielectric material; and
providing the at least one pulse of laser light to ablate the portion of the material by inducing a phase explosion.

18. The method of claim 17, wherein determining the absorption band wavelength comprises determining a vibrational absorption band wavelength of the dielectric material.

19. The method of claim 17, wherein providing the pulse of laser light comprises providing the pulse of light with an infra-red free-electron laser.

20. The method of claim 17, wherein providing the pulse of light with the laser comprises providing the pulse of light with at least one of an infrared-active gas laser and a solid-state laser operating in the infrared portion of the spectrum from roughly 1.5 to 15 micrometers.

21. The method of claim 17, wherein providing the pulse of light with the laser comprises providing a macropulse including a plurality of micropulses.

22. The method of claim 21, wherein providing the macropulse comprises providing a 4 μs macropulse.

23. The method of claim 21, wherein providing the macropulse including a plurality of micropulses comprises providing the macropulse including a plurality of micropulses with a duration of about 0.7 picoseconds to about 1.0 picoseconds.

24. The method of claim 17, wherein providing the pulse of laser light comprises providing the pulse of laser light at an intensity of at least about 4×10⁷ W/cm².

25. The method of claim 17, wherein providing the pulse of laser light comprises focusing the pulse of laser light using an optical element.

26. A method for forming structures in a dielectric material by ablating a portion of the dielectric material with a laser, comprising:
determining an absorption band wavelength of the dielectric material;
determining an intensity and a duration of a plurality of light pulses having the determined wavelength such that the pulses are capable of heating the portion of the dielectric material to approximately the critical temperature of the dielectric material on a time scale less than about the characteristic time scale for thermal diffusion in the dielectric material; and
providing the plurality of laser light pulses to ablate selected portions of the dielectric material by inducing a plurality of phase explosions.

27. The method of claim 26, wherein determining the absorption band wavelength comprises determining a vibrational absorption band wavelength of the dielectric material.

28. The method of claim 26, wherein providing the plurality of laser light pulses comprises providing the pulse of light with at least one of an infra-red free-electron laser, a high-pressure CO₂ or other infrared-active gas laser, and a solid-state laser operating in the infrared portion of the spectrum from roughly 1.5 to 15 micrometers.

29. The method of claim 26, wherein providing the plurality of laser light pulses to the selected portions of the dielectric material comprises providing a plurality of macropulses, each including a plurality of micropulses, to the selected portions of the dielectric material.

30. The method of claim 26, wherein providing the plurality of laser light pulses to the selected portions comprises focusing the laser light pulses on the selected portions using an optical element.

31. The method of claim 26, wherein providing the plurality of laser light pulses to the selected portions comprises providing the plurality of laser light pulses to the selected portions by changing the relative position of the laser and the dielectric material.

32. The method of claim 26, wherein providing the plurality of laser light pulses to the selected portions of the dielectric material comprises providing the plurality of laser light pulses to the selected portions of at least one of silica, calcite, and Pyrex®.

33. A method for ablating a dielectric material, comprising:
energizing a laser to provide light at a wavelength selected to correspond to an absorption band of the dielectric material;
directing said light onto said dielectric material; and
controlling the duration of said light to produce a phase explosion.

34. An apparatus for ablating a dielectric material having an absorption band, comprising:
a controller adapted to determine a wavelength corresponding to a characteristic wavelength of the absorption band, as well as an intensity and a duration such that a light pulse with the determined wavelength, intensity, and duration is capable of heating the portion of the dielectric material to approximately the critical temperature of the dielectric material on a time scale less than about the characteristic time scale for thermal diffusion in the dielectric material and thereby inducing a phase explosion in the dielectric material; and
a laser capable of providing at least one light pulse with the determined wavelength, intensity, and duration in response to a signal from the controller.

35. The apparatus of claim 34, wherein the dielectric material is a brittle dielectric material.

36. The apparatus of claim 34, wherein the dielectric material is at least one of silica, calcite, and Pyrex®.

37. The apparatus of claim 34, wherein the absorption band is a vibrational absorption band.

38. The apparatus of claim 34, wherein the laser is at least one of an infra-red free-electron laser, a high-pressure CO₂ or other infrared-active gas laser, and a solid-state laser operating in the infrared portion of the spectrum from roughly 1.5 to 15 micrometers.

39. The apparatus of claim 34, further comprising a first support element adapted to support the laser, wherein the laser is mobile when supported by the first support element.

40. The apparatus of claim 34, further comprising a second support element adapted to support the dielectric material, wherein the dielectric material is mobile when supported by the second support element.

41. The apparatus of claim 34, further comprising an optical element adapted to focus the laser pulse onto a portion of the sample.

42. The apparatus of claim 41, wherein the optical element comprises at least one of a lens, a mirror, a filter, and a polarizer.

43. The apparatus of claim 42, wherein the optical element is adapted to focus the laser pulse on a plurality of portions of the dielectric material.

44. The apparatus of claim 34, wherein the laser is adapted to provide a macropulse including a plurality of micropulses.

45. The apparatus of claim 44, wherein the macropulse is a 4 μs macropulse.

46. The apparatus of claim 44, wherein the plurality of micropulses have a duration of about 0.7 picoseconds to about 1.0 picoseconds.

47. The apparatus of claim 34, wherein the light pulse has an intensity of at least about 4×10⁷ W/cm².

48. The apparatus of claim 34, further comprising a controller adapted to control at least one of the first support element, the second support element, and the optical element.

49. An apparatus, comprising:
means for determining a wavelength using optical properties of a material;
means determining a light intensity and a pulse duration using optical and thermodynamic properties of the material and the determined wavelength; and
means for providing at least one pulse of light having the determined wavelength to ablate a portion of the material by inducing a phase explosion, wherein the pulse has the determined wavelength, intensity, and duration.

50. The apparatus of claim 49, further comprising means for determining the wavelength using at least one of a known absorption spectrum, an empirical relation, a direct measurement, and a computer model of the material.

51. The apparatus of claim 49, further comprising means for determining the light intensity and the pulse width such that the portion of the material is heated to approximately the critical temperature of the material on a time scale less than about the characteristic time scale for thermal diffusion in the material.

52. The apparatus of claim 49, further comprising means for providing the pulse of light including a macropulse that includes a plurality of micropulses.

53. The apparatus of claim 49, further comprising means for providing a plurality of pulses of light.
